(19) United States
(12) Patent Application Publication
(10) Pub. No.: US 2024/0227831 A1
(43) Pub. Date: Jul. 11, 2024

(54) INPUT-OUTPUT SYSTEM AND METHOD OF CONTROLLING THE SAME FOR VEHICLE

(71) Applicants: Hyundai Motor Company, Seoul (KR); Kia Corporation, Seoul (KR)

(72) Inventors: Cheoneum Park, Seongnam-Si (KR); Juae Kim, Seoul (KR); Seohyeong Jeong, Suwon-Si (KR)

(21) Appl. No.: 18/528,026

(22) Filed: Dec. 4, 2023

(30) Foreign Application Priority Data
Jan. 9, 2023 (KR) 10-2023-0002717

(51) Int. Cl. B60W 50/10; B60W 40/08; G06N 3/0499; H04W 4/44

(52) U.S. Cl. CPC B60W 50/10; B60W 40/08; G06N 3/0499; H04W 4/44; B60W 2040/089; B60W 2540/21; B60W 2556/45

(57) ABSTRACT

A system for a vehicle is provided. The system may include a wireless interface configured to connect a server with an input device and an output device of the vehicle. The server may store sample data, associated with the vehicle, that match a plurality of output responses corresponding respectively to the sample data. The server may generate, based on input data received, via the wireless interface from the input device of the vehicle, a sample datum from the stored sample data, retrieve, from the memory, an output response, of the plurality of output response, that matches the sample datum, output, via the wireless interface to the output device of the vehicle, the retrieved output response, perform multi-task learning based on the input data and the sample data, identify, based on the retrieved output response, a user intention, and cause, based on the identified user intention, the vehicle to be controlled.

### CROSS-REFERENCE TO RELATED APPLICATION

This application is based on and claims priority to Korean Patent Application No. 10-2023-0002717, filed on Jan. 9, 2023 in the Korean Intellectual Property Office, the disclosure of which is incorporated herein by reference.

### TECHNICAL FIELD

The disclosure relates to a question-and-answer system that may provide an answer to a question uttered by a user and a method of controlling the same.

### BACKGROUND

A dialogue system is a system capable of identifying a user's intention through a dialogue with the user and providing a service corresponding to the identified intention. In association with a specific device, the dialogue system also performs control on the device or provides specific information according to a user's intention.

Because users in vehicles have spatial and situational constraints on their movements, a dialogue system may be usefully used in a way that recognizes the user intention through the user's utterance and provides a service desired by the user.

In particular, high demand for a service providing an answer to a vehicle-related question of a user may perform research and development to improve the accuracy and quality of the service.

Regarding a frequently asked question (FAQ) system providing users with pre-set question-answer pairs for frequently asked questions, a distinction between questions with similar meanings may not be clear, resulting in incorrect answers. Accordingly, a more precise distinction is desirable.

### SUMMARY

According to the present disclosure, a system for a vehicle, the system may comprise: a wireless interface configured to connect a server with an input device and an output device of the vehicle; and the server comprising: one or more processors; and a memory storing: sample data, associated with the vehicle, that match a plurality of output responses corresponding respectively to the sample data; and instructions that, when executed by the one or more processors, may cause the server to: generate, based on input data received, via the wireless interface from the input device of the vehicle, a sample datum from the stored sample data; retrieve, from the memory, an output response, of the plurality of output response, that matches the sample datum; output, via the wireless interface to the output device of the vehicle, the retrieved output response; perform multi-task learning based on the input data and the sample data; identify, based on the retrieved output response, a user intention; and cause, based on the identified user intention, the vehicle to be controlled.

The system, wherein the instructions, when executed by the one or more processors, may further cause the system to: encode an input sequence corresponding to the input data; and classify the sample datum based on the encoded input sequence. The system, wherein the instructions, when executed by the one or more processors, further cause the system to: perform global encoding on the input sequence; and perform bidirectional encoding on the global encoded input sequence.

The system, wherein the instructions, when executed by the one or more processors, may further cause the system to: calculate a loss value of the classified sample datum; and adjust, based on the calculated loss value, a weight of a deep learning model used for the multi-task learning. The system, wherein the instructions, when executed by the one or more processors, may further cause the system to calculate a first loss value for the classified sample datum and a second loss value for contrastive learning.

The system, wherein the instructions, when executed by the one or more processors, may further cause the system to: sum up the first loss value and the second loss value to obtain a total loss value; and adjust, based on the total loss value, a weight of a deep learning model used for the multi-task learning. The system, wherein the instructions, when executed by the one or more processors, may further cause the system to calculate the second loss value based on a hidden state, a positive sample, and a negative sample for the input data.

The system, wherein the positive sample may include a vector corresponding to a correct output response based on classifying the sample datum, and wherein the instructions, when executed by the one or more processors, further cause the system to determine the negative sample based on fact scores of a plurality of vector outputs and based on classifying the sample datum. The system, wherein the negative sample may include a predetermined number of vectors having a highest fact score, excluding a vector corresponding to the correct output response, among the fact scores of the plurality of vector outputs based on classifying the sample datum. The system, wherein the sample data stored in the memory may include a frequently asked question (FAQ) related to the vehicle.

According to the present disclosure, a method for controlling a system, the method may comprise: establishing a communication channel, via a wireless interface and between: a server, and an input device of a vehicle and an output device of the vehicle; storing sample data, associated with the vehicle, that match a plurality of output responses corresponding respectively to the sample data; performing multi-task learning based on input data and based on the sample data; based on the multi-task learning, determining a sample datum, from among the stored same data, that corresponds to input data received, via the communication channel and from the input device of the vehicle; determining, from the plurality of output response, an output response that matches the determined sample datum; sending, via the communication channel to the output devices of the vehicle, the output response; identifying, based on the output response, a user intention; and causing, based on the identified user intention, the vehicle to be controlled.

The performing of the multi-task learning may comprise performing global encoding and a sequential encoding for an input sequence corresponding to the input data. The performing of the multi-task learning may comprise: calculating a loss value of a classified sample datum; and adjusting a weight of a deep learning model used for the multi-task learning based on the calculated loss value.

The performing of the multi-task learning may comprise calculating a first loss value for the classified sample datum and a second loss value for contrastive learning. The performing of the multi-task learning may comprise: summing the first loss value and the second loss value to obtain a total loss value; and adjusting, based on the total loss value, a weight of a deep learning model used for the multi-task learning.

The calculating of the second loss value may comprise calculating the second loss value based on a hidden state, a positive sample, and a negative sample for the input data. The positive sample includes a vector corresponding to a correct output response from classifying the sample datum, may further comprise: determining the negative sample based on fact scores of a plurality of vector outputs and based on classifying the sample datum.

The negative sample may include a predetermined number of vectors having a highest fact score, excluding a vector corresponding to the correct output response, among the fact scores of the plurality of vector outputs based on classifying the sample datum. The sample data stored may include a frequently asked question (FAQ) related to the vehicle.

According to the present disclosure, a non-transitory computer-readable recording medium storing instructions that, when executed by a system, may cause: establishing a communication channel, via a wireless interface and between: a server, and an input device of a vehicle and an output device of the vehicle; storing sample data, associated with the vehicle, that match a plurality of output response corresponding respectively to the sample data; performing multi-task learning based on input data and based on the sample data; based on the multi-task learning, determining a sample datum, from among the stored sample data, that corresponds to input data received, via the communication channel and from the input device of the vehicle; determining, from the plurality of output response, an output response that matches the determined sample datum; sending, via the communication channel to the output devices of the vehicle, the output response; identifying, based on the output response, a user intention; and causing, based on the identified user intention, the vehicle to be controlled.

### BRIEF DESCRIPTION OF THE DRAWINGS

These and/or other examples of the disclosure will become apparent and more readily appreciated from the following description of the examples, taken in conjunction with the accompanying drawings of which:

FIG. 1 shows an example of a question-and-answer system according to an example;

FIG. 2 shows an example of information stored in a memory of a question-and-answer system according to an example;

FIG. 3 shows an example of similar sentences used for learning of a question-and-answer system according to an example;

FIG. 4 shows another example of a question-and-answer system according to an example;

FIG. 5 shows an example of a configuration of a pre-processing module of a question-and-answer system according to an example;

FIG. 6 shows an example of a configuration of a feature extraction module in a question-and-answer system according to an example;

FIG. 7 shows an example of a feature extraction result of a question-and-answer system according to an example;

FIG. 8 shows an example of a format conversion result of a question-and-answer system according to an example.

FIG. 9 shows an example of a learning module of a question-and-answer system according to an example;

FIG. 10 shows an example of layer-specific operations of a learning module of a question-and-answer system according to an example;

FIG. 11 shows an example of information exchanged between a vehicle and a server;

FIG. 12 shows an example of a server including a question-and-answer system;

FIG. 13 shows an example of a vehicle connected to a server including a question-and-answer system; and

FIG. 14 shows an example of a flowchart showing steps of a method of controlling a question-and-answer system according to an example.

### DETAILED DESCRIPTION

Like reference numerals throughout the specification denote like elements.

Also, this specification does not describe all the elements according to examples of the disclosure, and descriptions well-known in the art to which the disclosure pertains or overlapped portions are omitted. The terms such as “˜part”, “˜module”, and the like may refer to at least one process processed by at least one hardware or software. According to examples, a plurality of “˜parts”, “˜modules” may be embodied as a single element, or a single of a “˜part”, “˜module” may include a plurality of elements.

The examples set forth herein and illustrated in the configuration of the present disclosure are only preferred examples, so it should be understood that they may be replaced with various equivalents and modifications at the time of the present disclosure.

Terminologies used herein are for the purpose of describing particular examples only and is not intended to limit the present disclosure. It is to be understood that the singular forms are intended to include the plural forms as well, unless the context clearly dictates otherwise. It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

Further, the terms such as “˜part”, “˜device”, “˜block”, “˜member”, “˜module”, and the like may refer to a unit for processing at least one function or act. For example, the terms may refer to at least a process processed by at least one hardware component, such as a field-programmable gate array (FPGA) and/or an application specific integrated circuit (ASIC), or software stored in memories or processors.

It will be understood that, although the terms first, second, etc. may be used herein to describe various elements, these elements should not be limited by these terms.

Reference numerals used for method steps are just used for convenience of explanation, but not to limit an order of the steps. Thus, unless the context clearly dictates otherwise, the written order may be practiced otherwise.

Meanwhile, the disclosed examples may be stored in the form of a recording medium storing computer-executable instructions. The instructions may be stored in the form of a program code, and when executed by a processor, the instructions may perform operations of the disclosed examples. The recording medium may be implemented as a computer-readable recording medium.

The computer-readable recording medium includes all kinds of recording media in which instructions which may be decoded by a computer are stored of, for example, a read only memory (ROM), random access memory (RAM), magnetic tapes, magnetic disks, flash memories, optical recording medium, and the like.

Hereinafter, a question-and-answer system and a method of controlling the question-and-answer system according to examples of the disclosure are described in detail with reference to the accompanying drawings.

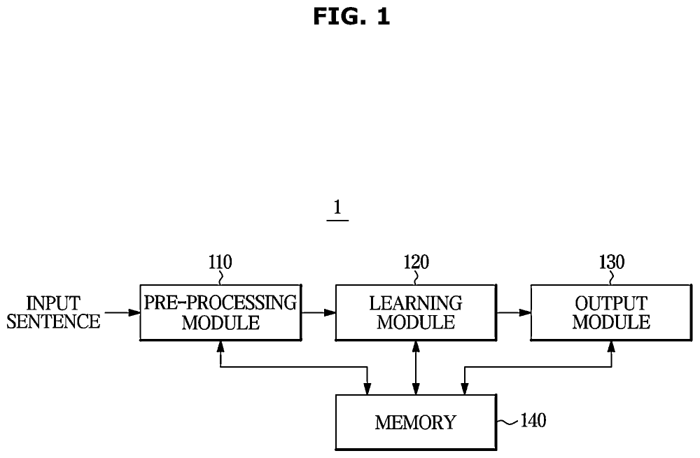

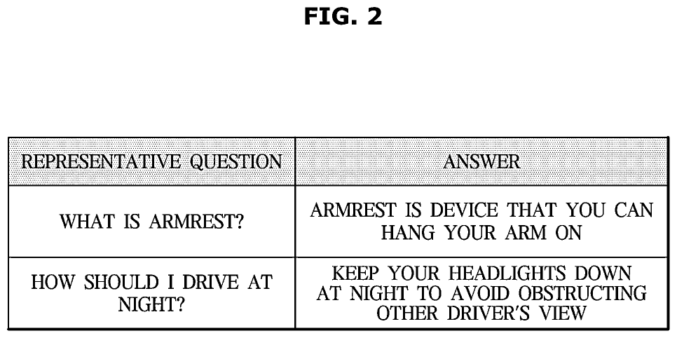

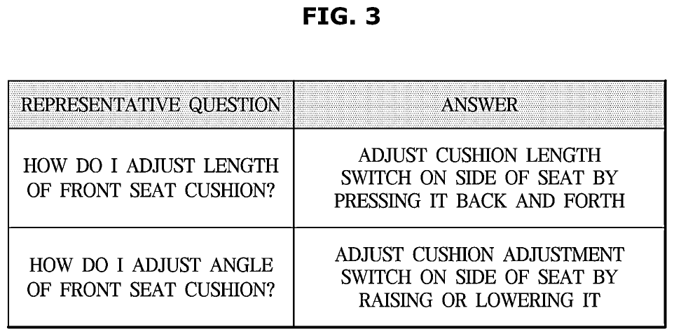

FIG. 1 shows an example of a question-and-answer system according to an example. FIG. 2 shows an example of information stored in a memory of a question-and-answer system according to an example. FIG. 3 shows an example of similar sentences used for learning of a question-and-answer system according to an example.

Referring to FIG. 1, a question-and-answer system 1 according to an example is illustrated. As shown, the question-and-answer system 1 includes a memory 140 in which a plurality of representative questions are stored to match a plurality of answers respectively corresponding to the plurality of representative questions, a learning module 120 configured to output a representative question corresponding to an input sentence from among the stored plurality of representative questions, and an output module 130 configured to search the memory 140 for an answer that matches the output representative question and output the retrieved answer.

The question-and-answer system 1 according to an example is a system that provides an answer to a question uttered by a user. Here, the question uttered by the user may be a predetermined frequently asked question (FAQ), and the question-and-answer system 1 may output an answer to the predetermined FAQ.

If the question-and-answer system 1 is associated with a vehicle, the question uttered by the user may be a vehicle-related FAQ. Accordingly, the question-and-answer system 1 may output an answer to the vehicle-related FAQ uttered by the user.

To this end, in the memory 140, a plurality of representative questions for respective FAQs related to a vehicle may be stored to match answers corresponding thereto, in the form of a question-and-answer pair as in the example of FIG. 2.

For example, for a representative question, “What is an armrest?”, an answer of “An armrest is a device that you can hang your arm on.” may be stored as a question-answer pair.

Also, for a representative question, “How should I drive at night?”, an answer “Keep your headlights down at night to avoid obstructing the other driver's view.” may be stored as a question-answer pair.

Because the meaning of each question shown in FIG. 2 is clearly different, the question-and-answer system may easily distinguish the questions. However, the question-and-answer system may not distinguish between questions similar to each other rather than significantly different in meaning.

Accordingly, the learning module 120 of the question-and-answer system 1 may identify a representative question corresponding to an arbitrary sentence uttered by the user from among the plurality of representative questions stored in the memory 140.

To this end, the learning module 120 may perform learning using a plurality of learning data sets including input data and output data, in which input sentences may be used as input data, and a plurality of representative questions corresponding respectively to the input sentences may be used as output data.

As shown in FIG. 3, representative questions, “How do I adjust the length of the front seat cushion?” and “How do I adjust the angle of the front seat cushion?”, are similar in meaning and may not be clearly distinguished.

In performing the above-described learning, the question-and-answer system 1 according to an example may perform multi-task learning of simultaneously learning a representative question corresponding to an input sentence.

When outputting a similar representative sentence to a specific input sentence due to existence of similar representative questions as shown in FIG. 3, data about both the representative sentences, that are a correct answer and those that are not, may be used for learning. By simultaneously learning tasks related to each other as described above, a performance of the learning module 120 may be improved.

To this end, the question-and-answer system 1 may perform learning by using input sentences as input data, and using a plurality of representative questions corresponding respectively to the input sentences as output data.

The multi-task learning is performed based on a deep learning model. Detailed descriptions of the multi-task learning of the learning module 120 are described below.

The output module 130 may search the memory 140 for a representative question corresponding to the input sentence, and output an answer matching the retrieved representative question.

Meanwhile, the input sentence uttered by the user may be converted into an appropriate format that may be processed by the deep learning model before being input to the learning module 120. To this end, the question-and-answer system 1 may include a pre-processing module 110 that converts the format of the input sentence.

Hereinafter, a pre-processing process for a user utterance will be described.

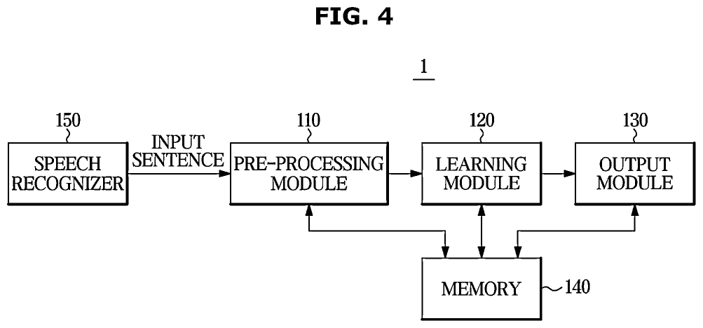

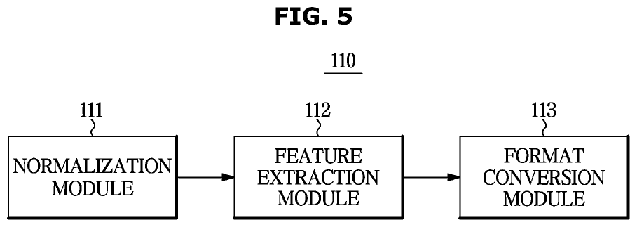

FIG. 4 shows another example of a question-and-answer system according to an example. FIG. 5 shows an example of a configuration of a pre-processing module of a question-and-answer system according to an example.

Referring to FIG. 4, the question-and-answer system 1 according to an example may further include a speech recognizer 150 that converts an utterance of a user, which is a speech signal, into text, that is, a sentence.

The speech recognizer 150 may be implemented as a speech to text (STT) engine, and may apply a speech recognition algorithm to the user utterance to convert the utterance into text.

For example, the speech recognizer 150 may use feature vector extraction technologies, such as Cepstrum, Linear Predictive Coefficient (LPC), Mel Frequency Cepstral Coefficient (MFCC), Filter Bank Energy, and the like, to extract a feature vector from the user utterance.

Then, the speech recognizer 150 may compare the extracted feature vector with a trained reference pattern to obtain a recognition result. To this end, an acoustic model that models and compares signal characteristics of a speech or a language model that models a linguistic order relationship of words or syllables corresponding to a recognized vocabulary may be used.

The speech recognizer 150 may also convert the user utterance into text based on a learning using a machine learning or deep learning. In the present example, there is no restriction on a method of converting an utterance of a user into text by the speech recognizer 150, and the speech recognizer 150 may convert an utterance of user into text by applying various speech recognition technologies in addition or alternative to the above-described method. In the below-described example, text output from the speech recognizer 150 is referred to as an input sentence.

The input sentence corresponding to the user utterance may be input to the pre-processing module 110 and converted into a form that may be processed by the deep learning model.

Referring to FIG. 5, the pre-processing module 110 may include a normalization module 111 normalizing the input sentence, a feature extraction module 112 extracting features from the input sentence, and a format conversion module 113 converting the format of the input sentence.

The normalization module 111 may perform normalization to exclude meaningless data, such as special characters and symbols, from the input sentence. It is assumed that all the input sentences processed in the components described below are normalized input sentences.

The feature extraction module 112 may extract features from the normalized input sentence, and the format conversion module 113 may assign indexes to the input sentence based on the extracted features.

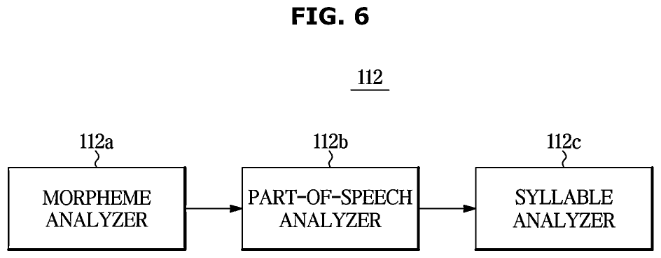

FIG. 6 shows an example of a configuration of a feature extraction module in a question-and-answer system according to an example.

Referring to FIG. 6, the feature extraction module 112 may include a morpheme analyzer 112a, a part-of-speech analyzer 112b, and a syllable analyzer 112c.

The morpheme analyzer 112a divides the input sentence in units of morphemes, and the part-of-speech analyzer 112b analyzes the part-of-speech for each morpheme and tags the part-of-speech for each morpheme.

The syllable analyzer 112c may divide the input sentence in units of syllables.

Because not only morphemes but also syllables are used as features, an unknown word or an infrequent word may be analyzed, so that the performance of the learning module 120 may be improved.

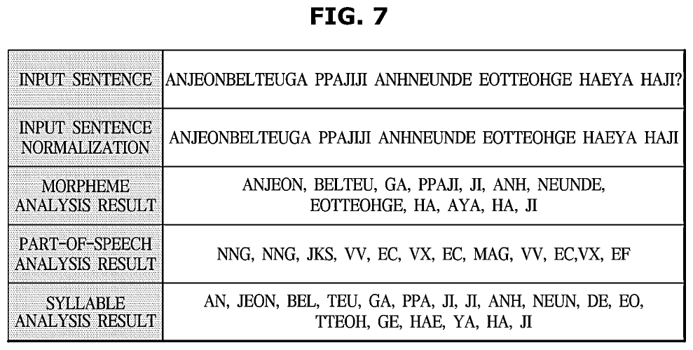

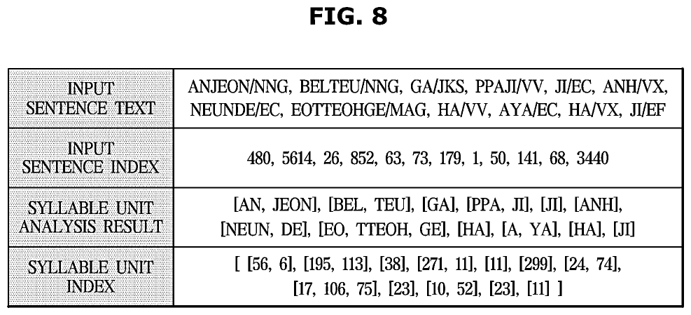

FIG. 7 shows an example of a feature extraction result of a question-and-answer system according to an example. FIG. 8 shows an example of a format conversion result of a question-and-answer system according to an example.

In the example below, described is the example where an input sentence is “ANJEONBELTEUGA PPAJIJI ANHNEUNDE EOTTEOHGE HAEYA HAJI?” (meaning that ‘the seatbelt won't come off, what should I do?’).

Referring to FIG. 7, the normalization module 111 may perform normalization on the input sentence to remove a special character “?”.

The morpheme analyzer 112a divides the normalized input sentence in units of morphemes, to output a result “ANJEON, BELTEU, GA, PPAJI, JI, ANH, NEUNDE, EOTTEOHGE, HA, AYA, HA, JI”.

The part-of-speech analyzer 112b may analyze the part-of-speech of each morpheme and tag the analyzed part-of-speech to each morpheme, to output a result, “ANJEON/NNG, BELTEU/NNG, GA/JKS, PPAJI/VV, JI/EC, ANH/VX, NEUND E/EC, EOTTEOHGE/MAG, HA/VV, AYA/EC, HA/VX, JI/EF”.

The syllable analyzer 112c may divide the normalized input sentence in units of syllables, to output a result “AN, JEON, BEL, TEU, GA, PPA, JI, JI, ANH, NEUN, DE, EO, TTEOH, GE, HAE, YA, HA, JI”.

According to an example, the input sentence is divided not only in units of morphemes but also in units of syllables, so that the input sentence may be subject to both word embedding and character embedding, as described below.

As described above, the format conversion module 113 may perform indexing on the input sentence based on the feature extraction result. Specifically, the format conversion module 113 may assign an index to each of a plurality of words or a plurality of features constituting the input sentence using a predefined dictionary. The index assigned in the format conversion process may indicate the position of a word in the dictionary.

The format conversion module 113 may perform indexing on the normalized input sentence “ANJEONBELTEUGA PPAJIJI ANHNEUNDE EOTTEOHGE HAEYA HAJI” in units of morphemes or in units of syllables, as shown in FIG. 8. Indexes assigned to the input sentence by the format conversion module 113 may be used in an embedding process to be described below.

In the example to be described below, the input sentence on which pre-processing has been completed will be referred to as an input sequence. The input sequence may be processed in units of tokens, and in the present example, tokens in units of morphemes are used.

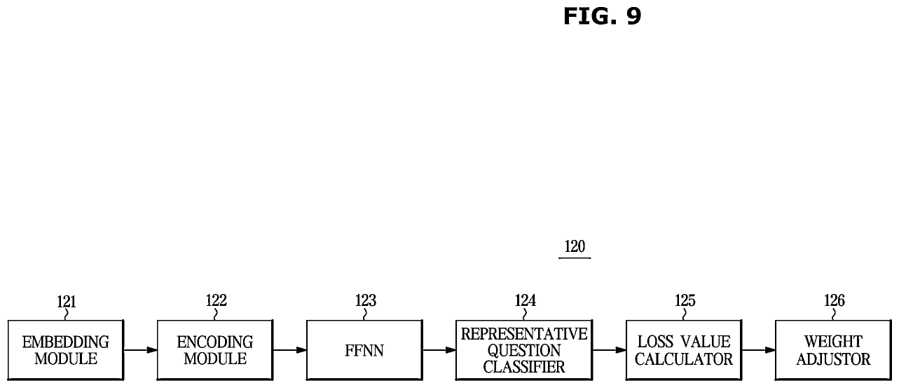

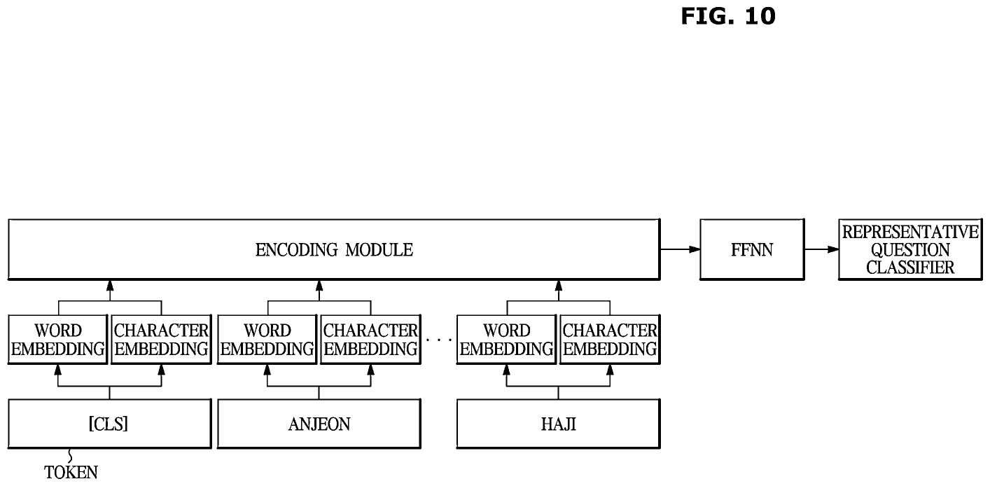

FIG. 9 shows an example of a learning module of a question-and-answer system according to an example. FIG. 10 shows an example of layer-specific operations of a learning module of a question-and-answer system according to an example.

According to an example, the learning module 120 may include a multi-task deep learning model that simultaneously learns a plurality of representative questions corresponding to an input sentence. Referring to FIG. 9, the learning module 120 may include an embedding module 121, an encoding module 122, a feed forward neural network (FFNN) 123, a representative question classifier 124, a loss value calculator 125, and a weight adjuster 126.

The embedding module 121 performs embedding to vectorize the input sequence. For example, the embedding module 121 may perform the embedding by applying a one-hot vector encoding method.

Specifically, if k words exist, a k-dimensional 0 vector may be generated, and only a corresponding word may be represented with an index of 1. To this end, redundant words are removed, the remaining words are listed, each of the words is converted into a one-hot vector, and the converted one-hot vectors are used to generate each sentence.

Referring to FIG. 10, a [CLS] token may be added to the input sequence input to the learning module 120. Through the encoding process described below, the vector for the [CLS] token may imply the meaning of the input sentence.

According to an example, the embedding module 121 may perform character embedding as well as word embedding. As described above, because the feature extraction module 112 extracts not only morpheme-unit features but also syllable-unit features, the syllable-unit features may also be input to the embedding module 121 and used for character embedding.

Since syllable-unit information provides information about similarity of words and is applicable to unknown or infrequent words that are not included in the word dictionary, use of both word-unit information and syllable-unit information may improve the performance of the deep learning model.

Meanwhile, pre-training may be used for word embedding and character embedding. For example, for Korean, word embedding may be pre-trained by a neural network language model (NNLM), and character embedding may be pre-trained by GloVe (Pennington et al., 2014). For English, word embedding and character embedding may be pre-trained by FastText (Bojanowski et al., 2017). If pre-trained embedding is used, the speed and performance of the deep learning model may be improved.

The embedding module 121 may output a word embedding vector eᵢ^{w}=emb_{w}(qᵢ) generated by performing word embedding on the input sequence and a character embedding vector eᵢ^{c}=CNN_{c}(qi) generated by performing character embedding on the input sequence, and the two types of embedding vectors may be concatenated and input to the encoding module 122.

The encoding module 122 may encode tokens of the input sequence represented as a vector through the embedding. The question-and-answer system 1 according to an example only classifies an input sequence without generating a new output sentence, and thus decoding may be omitted.

In order to improve the performance, the encoding module 122 may include a first encoding layer performing global encoding and a second encoding layer performing sequential encoding. Each of the first encoding layer and the second encoding layer may include a plurality of hidden layers.

The first encoding layer performing global encoding may encode the entire input sequence at once. The second encoding layer performing sequential encoding may sequentially receive tokens and perform encoding. The encoding module 122 according to an example may perform both global encoding and sequential encoding, thereby improving the accuracy of information about the order or position of words in the input sentence.

The first encoding layer and the second encoding layer may be implemented by various algorithms. For example, the first encoding layer may use an attention algorithm. According to the attention algorithm, a part of the entire input sequence that is related to a word to be predicted at a specific point in time may be referenced with attention.

As an example, the first encoding layer may use an encoder of a transformer (Vaswani et al., 2017) including a plurality of self-attention layers, and the second encoding layer may use an algorithm, such as a recurrent neural network (RNN) for sequential encoding, bidirectional gated recurrent units (BiGRU) performing bidirectional encoding, and the like.

In this case, hidden states si of the first encoding layer may each be input to the second encoding layer, and the second encoding layer may bidirectionally encode the hidden states to generate a sequentially encoded context vector rᵢ. The output sᵢ of the first encoding layer and the output rᵢ of the second encoding layer may be expressed by Equation 1 below.

sᵢ=Transformer(eᵢ)

rᵢ=BiRNN(rᵢ₋₁,sᵢ) [Equation 1]

In Equation 1, eᵢ, the input of the first encoding layer, is a dense vector in which a word embedding vector and a character embedding vector are concatenated.

On the other hand, the respective hidden states si of the first encoding layer may be input to the second encoding layer, and the hidden state s_{[CLS]} of the [CLS]token of the first encoding layer may be input to the feed forward neural network (FFNN) 123. The hidden state s_{[CLS]} of the [CLS] token may imply the meaning of the entire input sentence.

The last hidden state rₙ of the second encoding layer may also be input to the feed forward neural network (FFNN) 123. The hidden state s_{[CLS]} of the [CLS] token of the first encoding layer and the last hidden state rₙ of the second encoding layer may be concatenated and input to the feed forward neural network 123.

As described above, the learning module 120 may simultaneously learn question classification and category classification. To this end, the feed forward neural network (FFNN) 123 may perform a linear operation using a shared parameter for question classification and category classification. By passing through the feed forward neural network (FFNN) 123, the output of the first encoding layer and the output of the second encoding layer may be more naturally concatenated.

The output of the feed forward neural network (FFNN) 123 may be input to the representative question classifier 124.

The representative question classifier 124 may determine a representative question corresponding to the input sentence from among a plurality of predefined representative questions. For example, approximately 1700 representative questions may be predefined, and the representative question classifier 124 may use a linear function having a parameter through the feed forward neural network (FFNN) 123.

On the other hand, the question-and-answer system 1 according to an example may, in order to embed the representative question into a sentence vector, use a language model Bidirectional Encoder Representations from Transformers (BERT) (Reimers and Gurevych, 2019) to improve the performance of the representative question classifier 124.

The representative question classifier 124 may compare the sentence vector of the representative question with the encoded input sequence to classify a representative question corresponding to the input sentence. For example, the representative question classifier 124 may match the input sequence with the representative question using a softmax function, which is an activation function used in a classification task.

If a plurality of representative questions corresponding to the input sequence are output by the representative question classifier 124, the loss value calculator 125 may calculate a loss value for question classification.

In addition or alternative, the loss value calculator 125 may calculate a first loss value and a second loss value, and calculate a total loss value by summing the two loss values, which will be described later.

The weight adjuster 126 may adjust weights of the deep learning model used in multitask learning, based on the calculated total loss value.

The weight adjuster 126 may adjust the weights of the hidden layers of the deep learning model in a direction to reduce or minimize the calculated total loss value.

Hereinafter, described is performing multi-task learning by using contrastive learning as an auxiliary task in classifying representative questions.

As described above, the loss value calculator 125 may calculate a first loss value and a second loss value, and calculate a total loss value by summing the two loss values.

The first loss value is an indicator of whether appropriate processing has been performed if compared with a representative question which is a correct answer. Based on the first loss value, an appropriate weight may be found and accuracy may be increased.

The first loss value may refer to a loss value for question classification calculated by the loss value calculator 125, if the representative question classifier 124 outputs a plurality of representative questions corresponding to an input sentence.

According to the disclosure, the first loss value (Lq) may be calculated using a cross entropy error, which may be calculated as in Equation 2 below.

$${L}_{q} = - {\sum }_{i = 1}^{n} y log ( y ) \qquad [ Equation 2 ]$$

Here, y may refer to an output vector output from the representative question classifier 124.

The loss value calculator 125 may calculate the second loss value for contrastive learning.

Contrastive learning is a meta-learning technique that contrasts input data with positive and negative labels. In this instance, a distance between the input data and a positive sample may be learned to be close to each other in a vector, and a distance between the input data and a negative sample may be learned to be far apart in a vector.

A positive sample is an output vector to which a positive label is assigned, and a vector corresponding to a correct answer output from the representative question classifier 124 may correspond to the positive sample.

A negative sample is a vector to which a negative label is assigned, and may be the designated number of vectors having the highest fact score in output vectors for remaining representative questions, excluding correct answers from the plurality of representative questions output from the representative question classifier 124.

For example, except for vectors to which positive labels are assigned, negative labels may be assigned to three vectors with the highest fact score, which may be negative samples. However, negative labels may be assigned to a pre-specified number of vectors, without being limited to the above example.

Described is an example where an input sentence is “What type of battery does the card smart key use?” and the representative question classifier 124 outputs a plurality of representative questions, “What battery does the card smart key use?”, “What is the service charge?”, “What type of battery does the remote control smart key use?”, “Does the battery need to be replaced?”, and “Tell me how to replace the battery”.

Among the output representative questions, “What battery does the card smart key use?” is a representative question corresponding to the input sentence and may be a positive sample as a vector corresponding to a correct answer.

Also, among the remaining representative questions except for the positive sample, “What is the service charge?”, “What type of battery does the remote control smart key use?”, “Does the battery need to be replaced?”, and “Tell me how to replace the battery”, a plurality of vectors with high fact scores, which is the most similar to the correct answer, may be a negative sample.

Among the above examples, the three representative questions, “What type of battery does the remote control smart key use?”, “Does the battery need to be replaced?”, and “Tell me how to replace the battery”, may have the highest fact scores, and the representative question of “What is the service charge?” may have the lowest fact score.

In this instance, the output representative questions, “What type of battery does the remote control smart key use?”, “Does the battery need to be replaced?”, and “Tell me how to replace the battery”, may be negative samples.

According to the disclosure, in determining negative samples, a plurality of vectors with the highest fact score excluding correct answers may be extracted from a plurality of representative questions output each time during learning, and may be used as negative samples, without extracting the negative samples in advance.

By using the plurality of vectors with the high fact scores except for correct answers, misclassification of representative questions with similar meanings may be reduced.

The loss value calculator 125 may calculate the second loss value based on positive samples, negative samples, and hidden state for the input data.

If the hidden state for the input sentence is hₐ, a vector corresponding to the positive sample is hₚ, and a vector corresponding to the negative sample is hₜⁿ, the second loss value Lc for contrastive learning may be calculated as shown in Equation 3 below.

$${L}_{c} = \frac{1}{T} {\sum }_{t = 1}^{T} max \{ d ( {h}_{a} , {h}_{p} ) - d ( {h}_{a} , {{h}_{t}}^{n} ) + margin , 0 \} \qquad [ Equation 3 ]$$

In this instance, d(xᵢ, yᵢ)=∥xᵢ−yᵢ∥ and a margin may be a default value of 1.

The loss value calculator 125 may calculate a total loss value by summing the calculated first and second loss values. The weight adjuster 126 may adjust weights of the deep learning model used in multitask learning, based on the calculated total loss value.

The weight adjuster 126 may adjust the weights of the hidden layers of the deep learning model in a direction to reduce or minimize the calculated total loss value.

As such, question-answer pairs similar in meaning may be distinguished more clearly by the multi-task learning that learns representative question classification and performs contrastive learning.

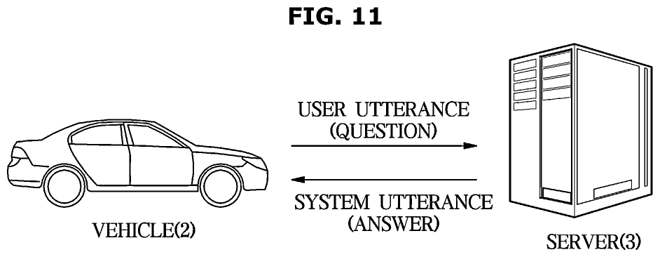

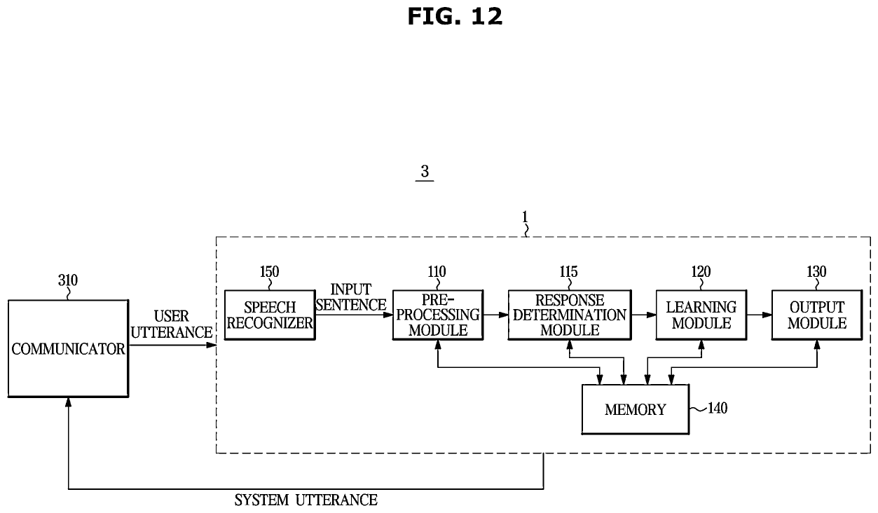

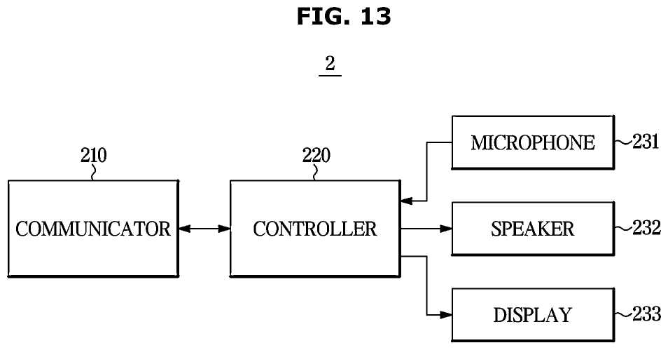

FIG. 11 shows an example of information exchanged between a vehicle and a server. FIG. 12 shows an example of a server including a question-and-answer system. FIG. 13 shows an example of a vehicle connected to a server including a question-and-answer system.

Referring to FIG. 11, if a user of a vehicle 2 inputs an utterance, the input user utterance may be transmitted to a server 3. The user utterance may include a vehicle-related question, and the server 3 including the question-and-answer system 1 may transmit a system utterance including an answer to the vehicle-related question to the vehicle 2.

Referring to FIG. 12, the server 3 may include a communicator 310 that transmits and receive signals to and from the vehicle 2 by communicating with the vehicle 2, and the question-and-answer system 1 described above. The communicator 310 may communicate with the vehicle 2 by employing at least one of various wireless communication methods, such as 4G, 5G, and Wi-Fi.

The communicator 310 may receive the user utterance transmitted from the vehicle 2 in the form of a speech signal. The speech recognizer 150 of the question-and-answer system 1 converts the user utterance into text (an input sentence) according to the method described above and input the text to the pre-processing module 110, which may output the pre-processed input text to the response determination module 115.

If the learning module 120, on which learning has been completed, is used in practice, category classification, loss value calculation, and weight adjustment may be omitted from the above-described operations of the question-and-answer system 1. Except for the category classification, loss calculation, and weight adjustment, the input sentence may be subject to pre-processing, embedding, and encoding and then classification of a representative question corresponding to the input sentence in the same manner as the above.

If the learning module 120 outputs the representative question corresponding to the input sentence, the output module 130 may search the memory 140 for an answer corresponding to the representative question, and transmit the retrieved answer to the vehicle 2 through the communicator 310.

The output module 130 may transmit the retrieved answer in the form of text or in the form of a speech signal. If transmitting the answer in the form of a speech signal, a text to speech (TTS) engine may be included in the output module 130.

Referring to FIG. 13, the vehicle 2 may include a communicator 210 communicating with the server 3, a controller 220 controlling the vehicle 2, and a microphone 231, a speaker 232, and a display 233 corresponding to a user interface.

A user utterance input to the microphone 231 may be converted into a form of a speech signal and then transmitted to the server 3 through the communicator 210. The communicator 210 of the vehicle 2 may also employ at least one of various wireless communication methods such as 4G, 5G, and Wi-Fi in communicating with the server 3.

If an answer corresponding to the question uttered by the user is transmitted from the server 3, the communicator 210 may receive the answer, and the controller 220 may output the answer using the speaker 232 or the display 233 according to the type of the answer.

For example, if the answer transmitted from the server 3 is text, the answer may be visually output through the display 233, and if the answer transmitted from the server 3 is a speech signal, the answer may be audibly output through the speaker 232.

Alternatively, even if the answer transmitted from the server 3 is text, the TTS engine included in the vehicle 2 may convert the transmitted answer into a speech signal, and output the answer converted into the voice signal through the speaker 232.

Hereinafter, a method of controlling a question-and-answer system according to an example is described. In implementing the method of controlling the question-and-answer system 1 according to an example, the above-described question-and-answer system 1 may be used. Accordingly, the contents described above with reference to FIGS. 1 to 13 may be equally applied to the method of controlling the question-and-answer system, unless otherwise mentioned.

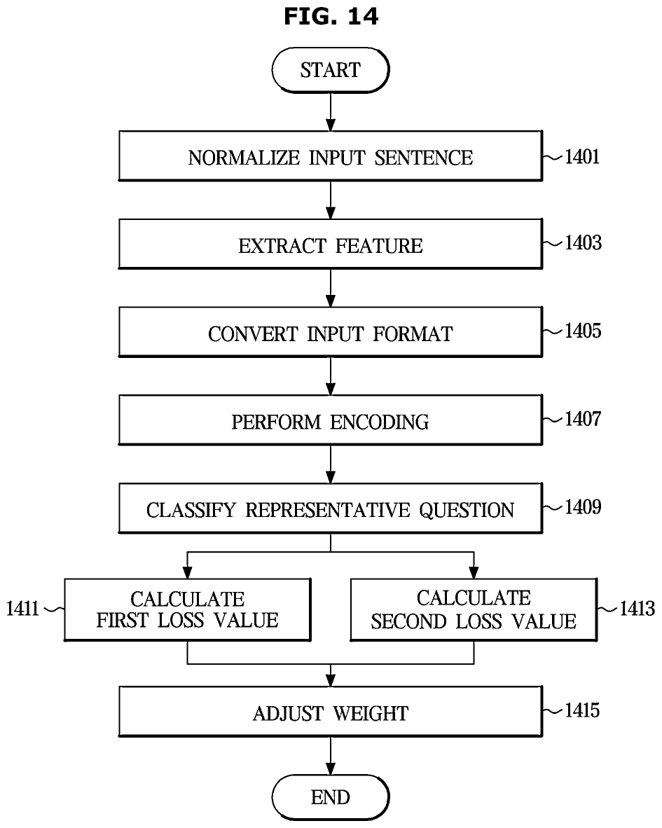

FIG. 14 shows an example of a flowchart showing steps of a method of controlling a question-and-answer system according to an example.

First, in order to perform the method of controlling the question-and-answer system, an input sentence may be input to the pre-processing module 110.

Referring to FIG. 14, the pre-processing module 110 normalizes the input sentence (1401). In the normalization operation of the input sentence, meaningless data, such as special characters and symbols, may be excluded from the input sentence. All the input sentences in the operations to be described below refer to normalized input sentences.

The pre-processing module 110 extracts a feature from the input sentence (1403). The features extracted from the input sentence may include a morpheme, a parts-of-speech, a syllable, and the like. Specifically, the pre-processing module 110 may divide the input sentence in units of morphemes, and the part-of-speech analyzer 112b may analyze the part-of-speech for each morpheme and tag the part-of-speech for each morpheme. Additionally or alternatively, if the input sentence is also divided in units of syllables and used as a feature, an unknown word or an infrequent word may also be analyzed, so that the performance of the learning module 120 may be improved.

The pre-processing module 110 converts an input format of the input sentence based on the extracted features (1405). Converting the input format may include performing indexing on the input sentence. The pre-processing module 110 may assign an index to each of a plurality of words or a plurality of features constituting the input sentence using a predefined dictionary. The index assigned in the format conversion process may indicate the position in the dictionary.

The input sentence on which pre-processing has been completed by the above-described process is referred to as an input sequence.

If embedding is performed on the input sequence based on the indexing result described above, the input sequence may be vectorized. In this case, both word embedding and character embedding may be performed. A word embedding vector generated by performing word embedding on the input sequence and a character embedding vector generated by performing character embedding on the input sequence may be concatenated and input to the encoding module 122.

The encoding module 122 performs encoding on the input sequence converted into a vector (1407). In order to improve performance, the encoding module 122 may include a first encoding layer performing global encoding and a second encoding layer performing sequential encoding. Each of the first encoding layer and the second encoding layer may include a plurality of hidden layers.

The first encoding layer performing global encoding may encode the entire input sequence at once, and the second encoding layer performing sequential encoding may sequentially receive tokens and perform encoding. By performing both global encoding and sequential encoding, the accuracy of information about the order or position of words in the input sentence may be improved. A detailed description of the encoding method is the same as in the example of the question-and-answer system 1.

The encoding result is input to each of the representative question classifier 124. As described in the above example, the encoding result may be input to the representative question classifier 124 after passing through the feed-forward neural network (FFNN) 123.

The representative question classifier 124 classifies representative questions (1409). Specifically, the representative question classifier 124 may compare sentence vectors of the representative questions with the encoded input sequence to determine representative questions corresponding to the input sentence.

If a plurality of representative questions corresponding to the input sentence are determined, the loss value calculator 125 calculates a first loss value for the question classification (1411) and calculates a second loss value for contrastive learning (1413).

The weight adjuster 126 may adjust weights of hidden layers of the deep learning model in a direction to reduce or minimize a calculated total loss value (1415).

An example of the disclosure provides a question-and-answer system and a method of controlling the same that may apply deep learning to classify vehicle-related frequently asked questions more clearly and provide more appropriate answers.

Additional examples of the disclosure will be set forth in part in the description which follows and, in part, will be obvious from the description, or may be learned by practice of the disclosure.

According to an example of the disclosure, a question-and-answer system may include: a memory in which a plurality of representative questions are stored to match a plurality of answers corresponding respectively to the plurality of representative questions; a learning module configured to output a representative question corresponding to an input sentence from among the stored plurality of representative questions; and an output module configured to search the memory for an answer that matches the output representative question and output the retrieved answer. The learning module may be configured to perform multi-task learning by using the input sentence as input data, and by using the plurality of representative questions corresponding to the input sentence as output data.

The learning module may include: an encoding module configured to encode an input sequence corresponding to the input data; and a question classifier configured to classify the representative question based on output of the encoding module.

The encoding module may include: a first encoding layer configured to perform global encoding on the input sequence; and a second encoding layer configured to perform bidirectional encoding on output of the first encoding layer.

The learning module may be configured to calculate a loss value of the classified representative question, and adjust a weight of a deep learning model used for the multi-task learning based on the calculated loss value.

The learning module may be configured to calculate a first loss value for the classified representative question and a second loss value for contrastive learning.

The learning module may be configured to adjust a weight of a deep learning model used for the multi-task learning based on a total loss value obtained by summing the first loss value and the second loss value.

The learning module may be configured to calculate the second loss value based on a hidden state, a positive sample, and a negative sample for the input data.

The positive sample may include a vector corresponding to a correct answer output from classifying the representative question, and the negative sample may be determined based on fact scores of a plurality of vectors output from classifying the representative question.

The negative sample may include a predetermined number of vectors having a highest fact score, excluding a vector corresponding to the correct answer, among the fact scores of the plurality of vectors output from classifying the representative question.

The plurality of representative questions stored in the memory may include a frequently asked question (FAQ) related to a vehicle.

According to an example of the disclosure, a method of controlling a question-and-answer system may include: storing a plurality of representative questions to match a plurality of answers corresponding respectively to the plurality of representative questions; performing multi-task learning by using an input sentence as input data, and by using the plurality of representative questions corresponding to the input sentence as output data; in response to the multi-task learning being completed, determining a representative question corresponding to an input sentence uttered by a user from among the stored plurality of representative questions based on a result of the multi-task learning; and determining an answer that matches the determined representative question from among the stored plurality of answers.

The performing of the multi-task learning may include performing global encoding and a sequential encoding for an input sequence corresponding to the input data.

The performing of the multi-task learning may include calculating a loss value of a classified representative question; and adjusting a weight of a deep learning model used for the multi-task learning based on the calculated loss value.

The performing of the multi-task learning may include calculating a first loss value for the classified representative question and a second loss value for contrastive learning.

The performing of the multi-task learning may include adjusting a weight of a deep learning model used for the multi-task learning based on a total loss value obtained by summing the first loss value and the second loss value.

The calculating of the second loss value may include calculating the second loss value based on a hidden state, a positive sample, and a negative sample for the input data.

The positive sample may include a vector corresponding to a correct answer output from classifying the representative question, and the negative sample may be determined based on fact scores of a plurality of vectors output from classifying the representative question.

The negative sample may include a predetermined number of vectors having a highest fact score, excluding a vector corresponding to the correct answer, among the fact scores of the plurality of vectors output from classifying the representative question.

The plurality of representative questions stored may include a frequently asked question (FAQ) related to a vehicle.

According to the disclosure, the question-and-answer system and the method of controlling the same may simultaneously learn representative question classification and contrastive learning on a plurality of representative questions with respect to an input sentence, thereby improving a performance of deep learning.

Also, by generating the deep learning model specific to vehicles and then using the deep learning model to provide answers to vehicle-related FAQs, representative questions with similar meanings may be classified more accurately.

As is apparent from the above, according to the examples of the disclosure, the question-and-answer system and the method of controlling the same may apply deep learning to classify vehicle-related frequently asked questions more clearly and provide more appropriate answers.

Although examples have been described for illustrative purposes, those skilled in the art will appreciate that various modifications, additions, alternatives, and substitutions are possible, without departing from the scope and spirit of the disclosure. Therefore, examples have not been described for limiting purposes.

What is claimed is:

1. A system for a vehicle, the system comprising:
a wireless interface configured to connect a server with an input device and an output device of the vehicle; and
the server comprising:
one or more processors; and
a memory storing:
sample data, associated with the vehicle, that match a plurality of output responses corresponding respectively to the sample data; and
instructions that, when executed by the one or more processors, cause the server to:
generate, based on input data received, via the wireless interface from the input device of the vehicle, a sample datum from the stored sample data;
retrieve, from the memory, an output response, of the plurality of output response, that matches the sample datum;
output, via the wireless interface to the output device of the vehicle, the retrieved output response;
perform multi-task learning based on the input data and the sample data;
identify, based on the retrieved output response, a user intention; and
cause, based on the identified user intention, the vehicle to be controlled.

2. The system of claim 1, wherein the instructions, when executed by the one or more processors, further cause the system to:
encode an input sequence corresponding to the input data; and
classify the sample datum based on the encoded input sequence.

3. The system of claim 2, wherein the instructions, when executed by the one or more processors, further cause the system to:
perform global encoding on the input sequence; and
perform bidirectional encoding on the global encoded input sequence.

4. The system of claim 2, wherein the instructions, when executed by the one or more processors, further cause the system to:
calculate a loss value of the classified sample datum; and
adjust, based on the calculated loss value, a weight of a deep learning model used for the multi-task learning.

5. The system of claim 2, wherein the instructions, when executed by the one or more processors, further cause the system to calculate a first loss value for the classified sample datum and a second loss value for contrastive learning.

6. The system of claim 5, wherein the instructions, when executed by the one or more processors, further cause the system to:
sum up the first loss value and the second loss value to obtain a total loss value; and
adjust, based on the total loss value, a weight of a deep learning model used for the multi-task learning.

7. The system of claim 5, wherein the instructions, when executed by the one or more processors, further cause the system to calculate the second loss value based on a hidden state, a positive sample, and a negative sample for the input data.

8. The system of claim 7, wherein the positive sample includes a vector corresponding to a correct output response based on classifying the sample datum, and wherein the instructions, when executed by the one or more processors, further cause the system to determine the negative sample based on fact scores of a plurality of vector outputs and based on classifying the sample datum.

9. The system of claim 8, wherein the negative sample includes a predetermined number of vectors having a highest fact score, excluding a vector corresponding to the correct output response, among the fact scores of the plurality of vector outputs based on classifying the sample datum.

10. The system of claim 1, wherein the sample data stored in the memory include a frequently asked question (FAQ) related to the vehicle.

11. A method for controlling a system, the method comprising:
establishing a communication channel, via a wireless interface and between:
a server, and
an input device of a vehicle and an output device of the vehicle;
storing sample data, associated with the vehicle, that match a plurality of output responses corresponding respectively to the sample data;
performing multi-task learning based on input data and based on the sample data;
based on the multi-task learning, determining a sample datum, from among the stored same data, that corresponds to input data received, via the communication channel and from the input device of the vehicle;
determining, from the plurality of output response, an output response that matches the determined sample datum;
sending, via the communication channel to the output devices of the vehicle, the output response;
identifying, based on the output response, a user intention; and
causing, based on the identified user intention, the vehicle to be controlled.

12. The method of claim 11, wherein the performing of the multi-task learning comprises performing global encoding and a sequential encoding for an input sequence corresponding to the input data.

13. The method of claim 11, wherein the performing of the multi-task learning comprises:
calculating a loss value of a classified sample datum; and
adjusting a weight of a deep learning model used for the multi-task learning based on the calculated loss value.

14. The method of claim 13, wherein the performing of the multi-task learning comprises calculating a first loss value for the classified sample datum and a second loss value for contrastive learning.

15. The method of claim 14, wherein the performing of the multi-task learning comprises:
summing the first loss value and the second loss value to obtain a total loss value; and
adjusting, based on the total loss value, a weight of a deep learning model used for the multi-task learning.

16. The method of claim 14, wherein the calculating of the second loss value comprises calculating the second loss value based on a hidden state, a positive sample, and a negative sample for the input data.

17. The method of claim 16, wherein the positive sample includes a vector corresponding to a correct output response from classifying the sample datum, further comprising:
determining the negative sample based on fact scores of a plurality of vector outputs and based on classifying the sample datum.

18. The method of claim 17, wherein the negative sample includes a predetermined number of vectors having a highest fact score, excluding a vector corresponding to the correct output response, among the fact scores of the plurality of vector outputs based on classifying the sample datum.

19. The method of claim 11, wherein the sample data stored include a frequently asked question (FAQ) related to the vehicle.

20. A non-transitory computer-readable recording medium storing instructions that, when executed by a system, cause:
establishing a communication channel, via a wireless interface and between:
a server, and
an input device of a vehicle and an output device of the vehicle;
storing sample data, associated with the vehicle, that match a plurality of output response corresponding respectively to the sample data;
performing multi-task learning based on input data and based on the sample data;
based on the multi-task learning, determining a sample datum, from among the stored sample data, that corresponds to input data received, via the communication channel and from the input device of the vehicle;
determining, from the plurality of output response, an output response that matches the determined sample datum;
sending, via the communication channel to the output devices of the vehicle, the output response;
identifying, based on the output response, a user intention; and
causing, based on the identified user intention, the vehicle to be controlled.
